(19) United States
(12) Patent Application Publication
(10) Pub. No.: US 2017/0127468 A1
(43) Pub. Date: May 4, 2017

(54) WIRELESS TERMINAL, METERING DEVICE, AND COMMUNICATION CONTROL METHOD

(71) Applicant: NEC Corporation, Tokyo (JP)

(72) Inventor: Naoki SAIKUSA, Tokyo (JP)

(73) Assignee: NEC Corporation, Tokyo (JP)

(21) Appl. No.: 15/128,319

(22) PCT Filed: Mar. 17, 2015
(86) PCT No.: PCT/JP2015/001463

§ 371 Date: Sep. 22, 2016

(30) Foreign Application Priority Data
Mar. 28, 2014 (JP) 2014-069042

(51) Int. Cl. H04W 76/02; H04W 4/00

(52) U.S. Cl. CPC H04W 76/028; H04W 4/005; H04W 4/008; H04W 84/18

(57) ABSTRACT

A wireless terminal (12) includes a wireless transceiver (121) and a controller (122). The wireless transceiver (121) is configured to adjust, according to magnitude of a path cost to reach a gateway node (11) in a wireless multi-hop network (10) formed by communication of the wireless transceiver (121), a waiting time before joining the wireless multi-hop network (10) after power supply restoration. As a result, for example, it is possible to contribute to stable reconfiguration of a wireless multi-hop network.

### TECHNICAL FIELD

The disclosure in this specification relates to a wireless multi-hop network and, in particular, to communication control for a wireless terminal performed when power supply is restored.

### BACKGROUND ART

As a short-range wireless communication technique suitable for a Machine to Machine (M2M) network or a sensor network, ZigBee, ZigBee PRO, and ZigBee IP have been known. ZigBee, ZigBee PRO, and ZigBee IP use wireless multi-hop communication. In this specification, a network using wireless multi-hop communication, such as by ZigBee, ZigBee PRO, and ZigBee IP, is referred to as a “wireless multi-hop network”.

Patent Literature 1 discloses that, in a wireless multi-hop network formed by a parent wireless device and a plurality of wireless devices, a hop count is considered to determine a communication path for each wireless device. Note that, a hop count is the number of intermediate wireless devices (i.e., the number of relay nodes) though which data passes between each wireless device and the parent wireless device. Patent Literature 1 is related to a tree-type network topology containing a parent wireless device as a root node and discloses that a communication path for each wireless device is determined in accordance with a fundamental rule that the hop count should be reduced as much as possible. Further, Patent Literature 1 discloses that when there are a number of wireless devices more than the maximum number of connections around a wireless device, the hop count is considered in order to determine downstream wireless devices (i.e., leaf nodes or child nodes) with which that wireless device communicates.

Patent Literature 2 discloses a technique similar to that of Patent Literature 1. That is, Patent Literature 2 discloses that, in a wireless multi-hop network formed by a gateway device and a plurality of wireless nodes, a hop count (i.e., the number of relay nodes) is considered to determine a communication path for each wireless node. Patent Literature 2 is related to a tree-type network topology containing a gateway device as a root node and discloses that a communication path for each wireless node is determined in accordance with a fundamental rule that the hop count should be reduced as much as possible.

### CITATION LIST

### Patent Literature

Patent Literature 1: Japanese Unexamined Patent Application Publication No. 2006-245854

Patent Literature 2: Japanese Unexamined Patent Application Publication No. 2010-141394

### SUMMARY OF INVENTION

### Technical Problem

The present inventor has examined an operation for resuming communication of a smart meter after a power failure in a wireless multi-hop network formed by a concentrator and a plurality of smart meters. Assume a case where a power failure affecting a plurality of smart meters has occurred and then the plurality of smart meters affected by the power failure resume communication after the power failure is recovered. In this case, as an example, it is conceivable that each of the plurality of smart meters, which have been affected by the power failure, starts a control procedure for joining a wireless multi-hop network in a random manner. However, such operations by the smart meters could require a long time for the reconfigured wireless multi-hop network to settle into a stable network state. For example, new smart meters that start up and newly join the wireless multi-hop network may cause a change of an existing communication path (i.e., multi-hop path to the concentrator) of an existing smart meter that has already started up before the new smart meters starts up.

Note that the above-described problem may occur not only in smart metering, but also widely in wireless multi-hop networks. That is, there is a possibility that when wireless terminals included in a wireless multi-hop network suspend their operations and then restart (i.e., resume communication), it could require a long time for the reconfigured wireless multi-hop network to settle into a stable network state.

In view of above, one object of embodiments disclosed in this specification is to provide a wireless terminal, a metering device, a communication control method, and a program contributing to stable reconfiguration of a wireless multi-hop network. Other objects or problems and novel features will be made apparent from the following description and the accompanying drawings.

### Solution to Problem

In an aspect, a wireless terminal includes a wireless transceiver and a control unit. The wireless transceiver is configured to communicate with a node. The control unit is configured to adjust, according to magnitude of a path cost to reach a gateway node in a wireless multi-hop network formed by communication of the wireless transceiver, a waiting time before joining the wireless multi-hop network after power supply restoration.

In an aspect, a metering device includes the above-described wireless terminal and a meter reading unit configured to collect meter reading data, and is configured to transmit the meter reading data to a remote system through the wireless multi-hop network.

In an aspect, a communication control method performed by a wireless terminal includes adjusting, according to magnitude of a path cost to reach a gateway node in a wireless multi-hop network, a waiting time before joining the wireless multi-hop network after restoration of power supply to the wireless terminal.

In an aspect, a program includes a set of instructions (software code) which, when loaded into a computer, cause the computer to perform the above-described communication control method.

### Advantageous Effects of Invention

According to the above-described aspects, it is possible to provide a wireless terminal, a metering device, a communication control method, and a program contributing to stable reconfiguration of a wireless multi-hop network.

### BRIEF DESCRIPTION OF DRAWINGS

FIG. 1 shows a configuration example of a wireless multi-hop network according to a first embodiment;

FIG. 2 shows a configuration example of a wireless terminal according to the first embodiment;

FIG. 3 shows an example of a definition of a waiting time;

FIG. 4 is a flowchart showing an example of a communication control procedure at the time of restoration of power supply to a wireless terminal according to the first embodiment;

FIG. 5 is a figure for explaining a reconfiguration of a wireless multi-hop network according to the first embodiment;

FIG. 6 shows a configuration example of an Advanced Metering Infrastructure (AMI) system including smart meters according to a second embodiment; and

FIG. 7 shows a configuration example of a smart meter according to the second embodiment.

### DESCRIPTION OF EMBODIMENTS

Specific embodiments are described hereinafter in detail with reference to the drawings. The same or corresponding elements are denoted by the same reference symbols throughout the drawings, and repeated descriptions are omitted as necessary for the sake of clarity.

### First Embodiment

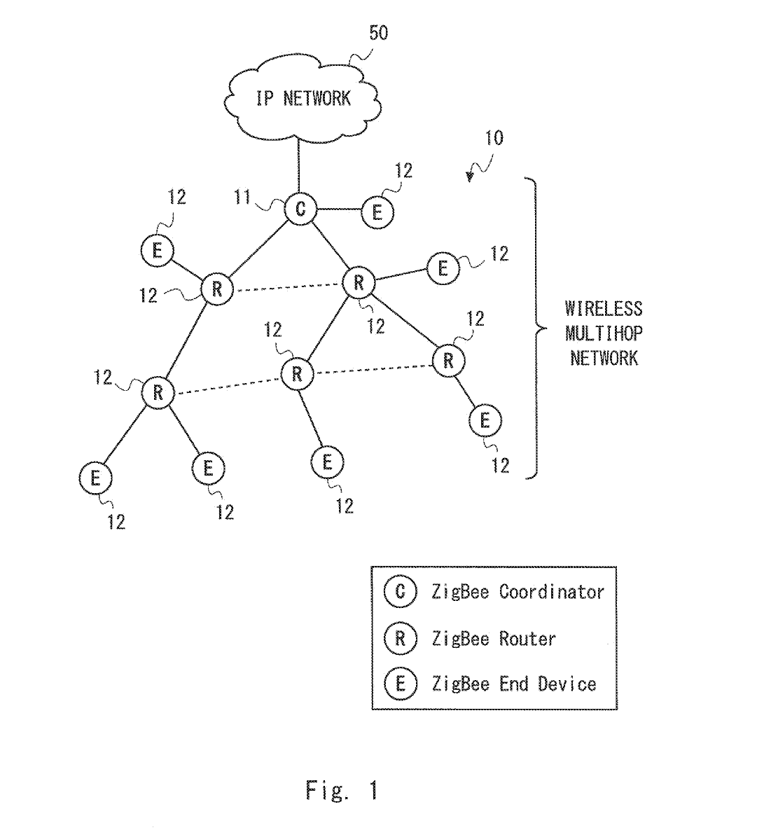

FIG. 1 shows a configuration example of a wireless multi-hop network 10 according to this embodiment. The example shown in FIG. 1 shows a case where the wireless multi-hop network 10 is a ZigBee, ZigBee PRO, or ZigBee IP network. The wireless multi-hop network 10 is formed by one coordinator 11 and a plurality of wireless terminals 12. In the case of the ZigBee or ZigBee PRO network, the coordinator 11 corresponds to a ZigBee coordinator and each wireless terminal 12 corresponds to a ZigBee router or a ZigBee end device. In the case of the ZigBee IP network, the coordinator 11 corresponds to a ZigBee IP coordinator and each wireless terminal 12 corresponds to a ZigBee IP router or a ZigBee IP host.

The coordinator 11 serves as a router in charge of multi-hop communication and forms the wireless multi-hop network 10. The process for forming the wireless multi-hop network 10 performed by the coordinator 11 includes: searching for available radio channels; and determining a radio channel and a network identifier (i.e., Personal Area Network (PAN) ID) used by the wireless multi-hop network 10.

Each wireless terminal 12 joins the wireless multi-hop network 10, which is generated and managed by the coordinator 11. Each wireless terminal 12 serves as a router in charge of multi-hop communication or as an end device having no router function.

Further, in the example shown in FIG. 1, the coordinator 11 is disposed on a boundary with an external network 50 (e.g., an Internet Protocol (IP) network) and serves as a gateway (or a gateway node) that relays data between the wireless multi-hop network 10 and the external network 50. However, one of the wireless terminals 12, which is not the coordinator 11 but serves as a ZigBee router or a ZigBee IP router, may also serve as the gateway. In FIG. 1, solid lines between nodes indicate multi-hop paths (parent-child relations) used for data transfer between the coordinator 10, which serves as the gateway, and each wireless terminal 12. In FIG. 1, dashed lines between nodes indicate associations (radio links) between wireless terminals 12 other than the multi-hop paths (parent-child relations)

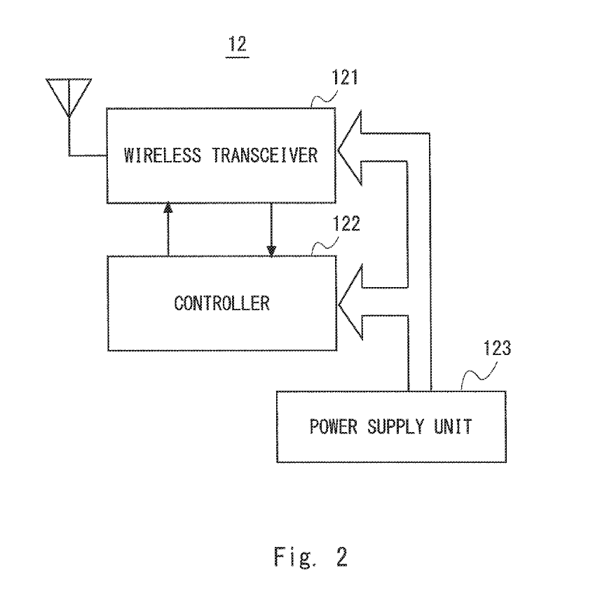

FIG. 2 is a block diagram showing a configuration example of the wireless terminal 12. The wireless terminal 12 includes a wireless transceiver 121, a controller 122, and a power supply unit 123. The wireless transceiver 121 is configured to perform wireless communication with an adjacent node. For example, the physical layer of the wireless transceiver 121 may conform to IEEE 802.15.4 or IEEE 802.15.4g, and its Media Access Control (MAC) layer (data link layer) may conform to IEEE 802.15.4.

The controller 122 provides services on upper layers including a network layer necessary for data transfer in the wireless multi-hop network 10. Further, the controller 122 performs a control procedure for joining the wireless multi-hop network 10 (hereinafter also referred to as a “joining procedure”). The joining procedure to the wireless multi-hop network 10 is a control procedure necessary to allow the wireless terminal 12 to connect to the wireless multi-hop network 10 as a router or an end device (an IP host) and perform data transmission and reception through the wireless multi-hop network 10. The joining procedure to the wireless multi-hop network 10 may include a plurality of procedures.

The joining procedure to the wireless multi-hop network 10 may include, for example, at least one of (a) a search of a PAN (the wireless multi-hop network 10), (b) a procedure for establishing an association with an adjacent node, (c) an authentication procedure performed between the wireless terminal 12 and the coordinator 11 (or the gateway), and (d) a procedure for setting a multi-hop path between the coordinator 11 (or the gateway) and the wireless terminal 12.

In the case where the wireless multi-hop network 10 conforms to ZigBee, ZigBee PRO, or ZigBee IP, the joining procedure to the wireless multi-hop network 10 may include at least one of (a) transmission of a Beacon Request message to an adjacent node, (b) transmission of an Association Request message to an adjacent node, (c) transmission of an authentication request message to the coordinator 11 (or the gateway), (d) a procedure for obtaining an IP address, (e) transmission of a DODAG Information Solicitation message to an adjacent node, and (f) transmission of a DODAG Destination Advertisement Object message to the coordinator 11 (or the gateway).

The power supply unit 123 supplies electric power to the wireless transceiver 121 and the controller 122. More specifically, the power supply unit 123 generates internal electric power from a battery (not shown) or an external power supply (not shown). The internal electric power is supplied to devices in the wireless terminal 12, including the wireless transceiver 121 and the controller 122. In an example, the power supply unit 123 converts alternating current (AC) power from an external power supply into direct current (DC) power and generates DC voltages suitable for the wireless transceiver 121 and the controller 122.

Next, a communication control procedure performed at the time of restoration of power supply to the wireless terminal 12 is described hereinafter. When the power supply is restored, the wireless terminal 12 (the controller 122) acquires a path cost to reach the coordinator 11 (or the gateway) at the point when the wireless terminal 12 had joined the wireless multi-hop network 10 in the past. The wireless terminal 12 may store a value of the path cost in a nonvolatile memory (not shown) within the wireless terminal 12 when the wireless terminal 12 is connected to the wireless multi-hop network 10 and is normally operating. The wireless terminal 12 (the controller 122) adjusts a timing at which the wireless terminal 12 stars to join the wireless multi-hop network 10 after the power supply restoration, according to the magnitude of the path cost obtained previously. Specifically, the wireless terminal 12 (the controller 122) may delay the timing at which the wireless terminal 12 joins the wireless multi-hop network 10 in such a manner that the larger the previous path cost is, the more the wireless terminal 12 delays the timing. In other words, the wireless terminal 12 (the controller 122) may adjust, according to the magnitude of the path cost, a waiting time that the wireless terminal 12 waits before joining the wireless multi-hop network 10 after the power supply restoration. Specifically, the wireless terminal 12 (the controller 122) may increase the waiting time in such a manner that the larger the path cost is, the more the waiting time is increased.

Note that the “power supply restoration” of the wireless terminal 12 means a change from a state in which the wireless transceiver 121 and the controller 122 in the wireless terminal 12 cannot perform their normal operations due to poor power supply to a state in which the power supply is restored and hence the wireless transceiver 121 and the controller 122 can start their normal operations. Accordingly, the power supply restoration of the wireless terminal 12 may be defined as a situation in which sufficient electric power is supplied to the wireless terminal 12 (the power supply unit 123). Alternatively, the power supply restoration of the wireless terminal 12 may be defined as a situation in which sufficient operating power is supplied to the wireless transceiver 121 and the controller 122 in the wireless terminal 12. Further, to put it in other words, the power supply restoration of the wireless terminal 12 can be expressed as the restart of the wireless terminal 12.

The path cost to reach the coordinator 11 (or the gateway) from the wireless terminal 12 can be defined by using various metrics. In some implementations, a path cost used for determining a multi-hop path by a routing protocol in the wireless multi-hop network 10 may be used as the path cost in this embodiment. For example, the path cost may be a hop count (i.e., the number of relay nodes) necessary to reach the coordinator 11 (or the gateway) from the wireless terminal 12. A small hop count means a small path cost. Alternatively, the path cost may be defined by using a radio link quality (e.g., Received Signal Strength Indicator (RSSI)). Further, the path cost may be defined by using a plurality of metrics, e.g., the hop count and the radio link quality. The path cost may also be referred to as a “distance”.

The adjustment of the timing of joining the wireless multi-hop network 10 can be performed by adjusting a start timing of a joining procedure to the wireless multi-hop network 10. Specifically, the wireless terminal 12 (the controller 122) may delay the start timing at which the wireless terminal 12 starts the joining procedure to the wireless multi-hop network 10 in such a manner that the larger the previous path cost is, the more the wireless terminal 12 delays the timing.

The adjustment of the timing of joining the wireless multi-hop network 10 may be performed by adjusting a waiting time until the start of the joining procedure after the power supply restoration. The relation between the length of the waiting time and the magnitude of the path cost may be determined in advance. That is, the waiting time may be determined in advance in such a manner that the larger the path cost is, the longer the waiting time becomes.

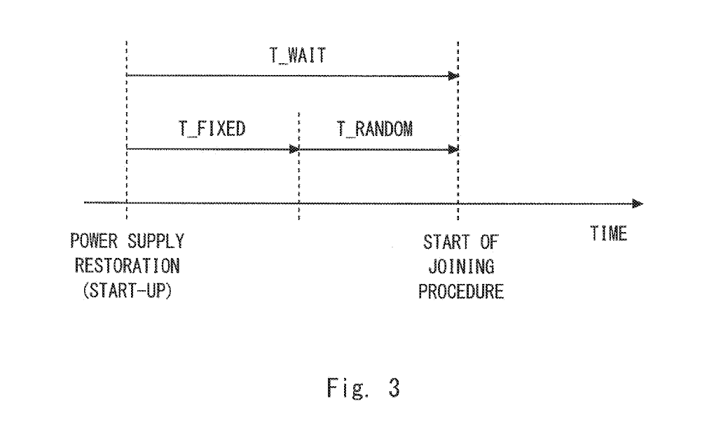

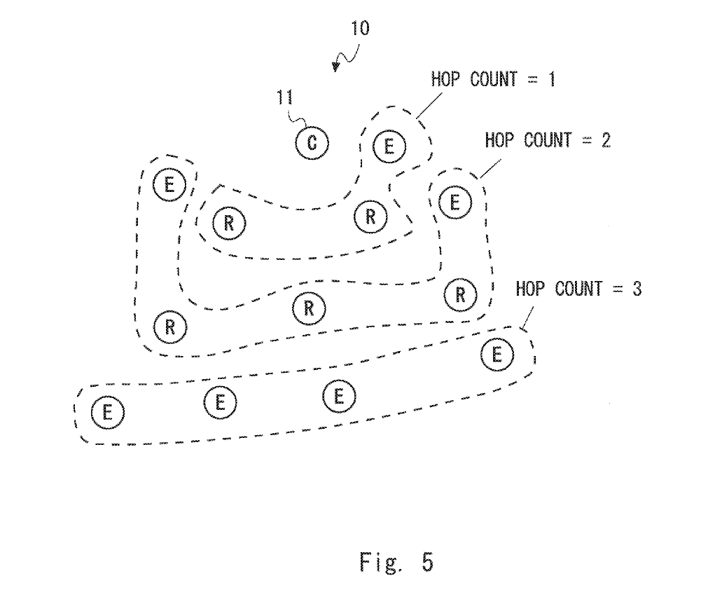

In another example, the adjustment of the timing of joining the wireless multi-hop network 10 may be performed by changing the length of a fixed period (T_FIXED) shown in FIG. 3. FIG. 5 shows an example of the definition of the waiting time (T_WAIT). In FIG. 3, the waiting time (T_WAIT) is defined as the sum of the fixed period (T_FIXED) and the random period (T_RANDOM). The fixed period (T_FIXED) is a period that the wireless terminal 12 has to wait. That is, the fixed period (T_FIXED) specifies the minimum time that the wireless terminal 12 has to wait. Meanwhile, the length of the random period (T_RANDOM) shown in FIG. 3 is randomly determined. The minimum time that the wireless terminal 12 has to wait can be changed by changing the length of the fixed period (T_FIXED).

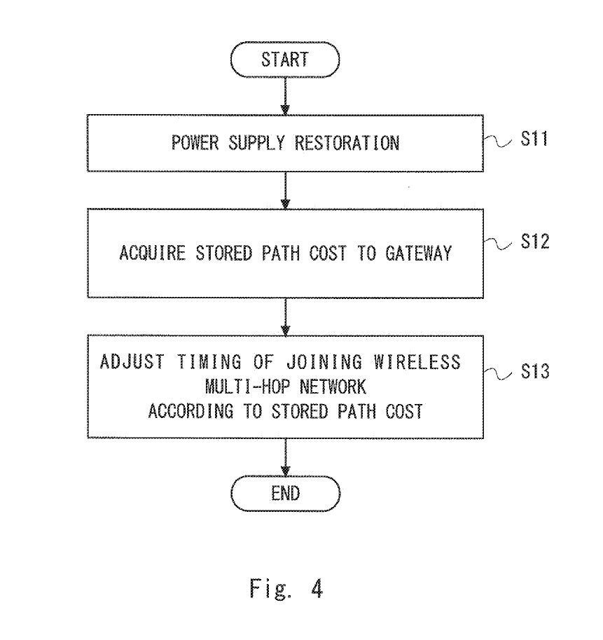

FIG. 4 is a flowchart showing an example of the communication control procedure at the time of restoration of power supply to the wireless terminal 12. In a step S11, the power supply to the wireless terminal 12 is restored. That is, operating power is supplied to modules in the wireless terminal 12, including the wireless transceiver 121 and the controller 122, and hence these modules start up.

In a step S12, the controller 122 reads a path cost to the coordinator 11 (or the gateway) that has been stored in the nonvolatile memory of the wireless terminal 12. As described previously, this path cost is a path cost at the point when the wireless terminal 12 had joined the wireless multi-hop network 10 in the past.

In a step S13, the controller 122 adjusts a timing at which the wireless terminal 12 joins the wireless multi-hop network 10 according to the value of the path cost read from the nonvolatile memory of the wireless terminal 12. The controller 122 may adjust the start timing of the joining procedure to the wireless multi-hop network 10 according to the value of the path cost. The controller 122 may adjust a waiting time that the wireless terminal 12 waits before joining the wireless multi-hop network 10 after the power supply restoration, according to the value of the path cost. The controller 122 may delay the start timing of the joining procedure to the wireless multi-hop network 10 in such a manner that the larger the path cost is, the more the controller 122 delays the start timing. The controller 122 may increase the waiting time that the wireless terminal 12 waits before joining the wireless multi-hop network 10 in such a manner that the larger the path cost is, the more the waiting time is increased.

In FIG. 5, twelve wireless terminals 12 shown in FIG. 1 are divided into groups according to their hop counts. Assume a situation in which the all twelve wireless terminals 12 stopped due to a wide-area power failure or the like and then these wireless terminals 12 restart upon the power supply restoration. When the hop count is used as the path cost, firstly, three wireless terminals 12 each of which has a hop count of one (hop count=1) start the joining procedure to the wireless multi-hop network 10. Next, five wireless terminals 12 each of which has a hop count of two (hop count=2) start the joining procedure to the wireless multi-hop network 10. Lastly, four wireless terminals 12 each of which has a hop count of three (hop count=3) start the joining procedure to the wireless multi-hop network 10.

As understood from the above explanation, according to the communication control method in accordance with this embodiment, the wireless terminals 12 can join the wireless multi-hop network 10 in an orderly manner in the ascending order of their path costs at the point prior to the power failure. As a result, it is possible to decrease the possibility that the joining procedure to the wireless multi-hop network 10 performed upon the power supply restoration by the wireless terminal 12 ends in failure and thereby to contribute to stable reconfiguration of the wireless multi-hop network 10. This is because at the timing at which one of the wireless terminals 12 performs the joining procedure to the wireless multi-hop network 10, there is a high possibility that one or more upstream-located wireless terminals 12, which are closer to the coordinator 11 (or the gateway) and have smaller path costs to the coordinator 11 (or the gateway), have already joined the wireless multi-hop network 10. Therefore, this embodiment can prevent problems which would otherwise occur due to the absence of the upstream-located wireless terminals 12, such as a failure of a joining procedure to the wireless multi-hop network 10 and an occurrence of a transient network topology different from the one before the power failure.

Note that the path cost to be used to determine the timing of joining the wireless multi-hop network 10 is preferably a path cost obtained at the time when the wireless multi-hop network 10 is stable. The state where the wireless multi-hop network 10 is stable is, for example, a state where the connection relation with adjacent nodes does not frequently change and the multi-hop path to reach the coordinator 11 (or the gateway) does not frequently change.

As an example, in order to refer to a path cost obtained at the time when the wireless multi-hop network 10 is stable, the wireless terminal 12 (the controller 122) may use a value of the path cost that was stored at least a predetermined time before detection of the power failure in the wireless terminal 12.

In another example, the wireless terminal 12 (the controller 122) may use a value of the path cost that was stored when the value of the path cost had remained unchanged for at least a predetermined time.

Further, in another example, the wireless terminal 12 (the controller 122) may use a value of the path cost that was stored when the multi-hop path between the coordinator 11 (or the gateway) and the wireless terminal 12 had remained unchanged for at least a predetermined time.

Further, in another example, the wireless terminal 12 (the controller 122) may use a value of the path cost that was stored before the wireless terminal 12 receives a notification indicating the occurrence of a power failure from an adjacent node in the wireless multi-hop network

Note that, one of the known uses of a wireless multi-hop network is smart metering. A smart meter has a function of collecting meter reading data indicating watt-hour, gas usage, or water usage, and a function of communicating bidirectionally with a remote system, thereby transmitting the meter reading data to the remote system. The remote system that is connected to smart meters through a communication network is referred to as a “Meter Data Management System (MDMS)”. The MDMS communicates bidirectionally with smart meters, analyzes meter reading data sent from these smart meters, and controls these smart meters.

In an example, a smart meter is equipped with a short-range wireless module conforming to ZigBee, ZigBee PRO, ZigBee IP, or the like, and transmits meter reading data to an MDMS through multi-hop communication among smart meters. The wireless multi-hop network for transmitting meter reading data is formed by a concentrator and a plurality of smart meters. That is, meter reading data transmitted from a smart meter arrives at the concentrator through multi-hop communication among smart meters and is transferred to the MDMS through the concentrator. The concentrator aggregates meter reading data transmitted from a plurality of smart meters and transmits the aggregated meter reading data to the MDMS. The concentrator is attached to, for example, a utility pole in which a power transmission line and a transformer are installed. The communication between the concentrator and the MDMS may use a wired communication network such as power line communication or use a public radio communication network (e.g., WiMAX, Mobile WiMAX, Universal Mobile Telecommunications System (UMTS), Long Term Evolution (LTE), CDMA2000 system, or Global System for Mobile communications (GSM (Registered Trademark))/General packet radio service (GPRS) system). Since the concentrator is in charge of a data relay performed on the boundary between the wireless multi-hop network and an external network, the concentrator may also be referred to as a “gateway”.

The technical idea described in this embodiment may be especially effective for the use in smart metering or the like. This is because in the case of smart metering, since each smart meter is installed in a fixed manner and hence has no mobility, there is a high possibility that the stable state of the wireless multi-hop network 10 in the past will also be stable in the future. Further, since in most cases smart meters operate with AC power supplied through a power transmission network, it is possible that a plurality of smart meters may stop their operations simultaneously due to a wide-area power failure. In the case of smart metering, the wireless terminal 12 is installed in a smart meter. In the below-described second embodiment, an example in which a wireless multi-hop network 10 according to the first embodiment is used for smart metering is shown.

### Second Embodiment

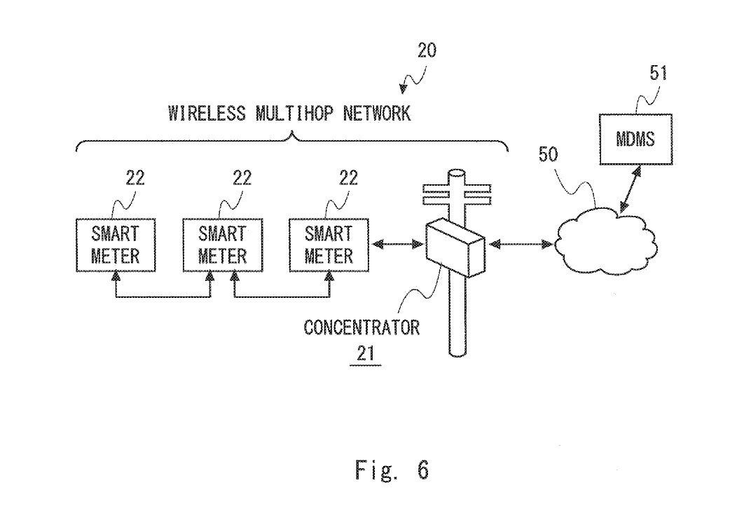

In this embodiment, a more concrete example of the first embodiment is described. FIG. 6 shows a configuration example of an Advanced Metering Infrastructure (AMI) system according to this embodiment. The AMI system shown in FIG. 6 includes a concentrator 21 and a plurality of smart meters 22. The concentrator 21 and the plurality of smart meters 22 form a wireless multi-hop network 20.

The concentrator 21 aggregates meter reading data transmitted from the plurality of smart meters 22 and transmits the aggregated meter reading data to an MDMS 51. The concentrator 21 is attached to, for example, a utility pole in which a power transmission line and a transformer are installed. The communication between the concentrator 21 and the MDMS 51 may use a wired communication network such as power line communication or use a public radio communication network.

Each smart meter 22 transmits meter reading data to the MDMS 51 through the concentrator 21. The meter reading data indicates, for example, watt-hour, gas usage, or water usage. Each smart meter 22 may transmit meter reading data with time information for specifying its measurement period (e.g., the start time of the measurement period).

Each smart meter 22 may perform other monitoring or controlling operations in cooperation with the MDMS 51. For example, each smart meter 22 may adjust the measurement period of meter reading data (e.g., 15-minute period, 30-minute period, or one-hour period) according to an instruction from the MDMS 51. Further, each smart meter 22 may transmit past meter reading data held in its memory in response to a request from the MDMS 51. Further, each smart meter 22 may control a switch or a valve in order to adjust, for example, watt-hour, gas usage, or water usage in response to an instruction from the MDMS 51.

The concentrator 21 serves as a gateway between the wireless multi-hop network and an external network 50 in order to communicate with the MDMS 51. The concentrator 21 has a function of the coordinator 11 or a function of the wireless terminal 12 (a router) described in the first embodiment. When the concentrator 21 does not have the function of the coordinator 11, a node other than the concentrator 21 may have the function of the coordinator 11.

Each smart meter 22 has a function of the wireless terminal 12 (a router or an end device) described in the first embodiment. That is, each smart meter 22 adjusts a waiting time that the smart meter 22 waits before joining the wireless multi-hop network 20 after the restoration of power supply to the smart meter 22, according to the magnitude of a path cost to reach the concentrator 21 (i.e., the gateway) at the point when the smart meter 22 had joined the wireless multi-hop network 20 in the past. Specifically, the smart meter 22 may delay the timing of joining the wireless multi-hop network 20 in such a manner that the larger the previous path cost is, the more the smart meter 22 delays the timing. The adjustment of the timing of joining the wireless multi-hop network 20 may be performed by adjusting a start timing of the joining procedure.

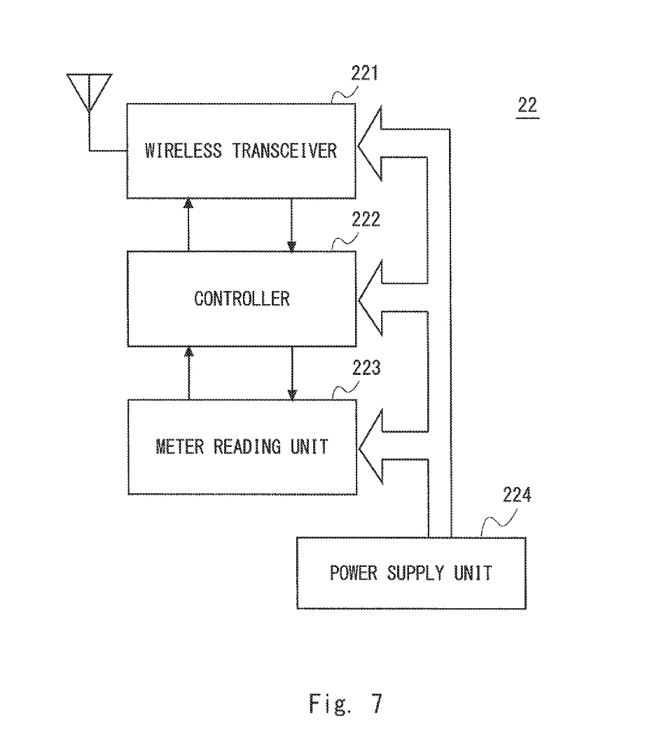

FIG. 7 is a block diagram showing a configuration example of the smart meter 22. The smart meter 22 shown in FIG. 7 includes a wireless transceiver 221, a controller 222, a meter reading unit 223, and a power supply unit 224. The wireless transceiver 221 has a function similar to that of the wireless transceiver 121 shown in FIG. 2. The controller 222 has a function similar to that of the controller 122 shown in FIG. 2. Further, the controller 222 is adapted to transmit meter reading data collected by the meter reading unit 223 to the MDMS 51 through the wireless transceiver 221. The meter reading unit 223 collects meter reading data for each predetermined measurement period (e.g., 15-minute period, 30-minute period, or one-hour period). The power supply unit 224 supplies electric power to the wireless transceiver 221, the controller 222, and the meter reading unit 223. In an example, the power supply unit 224 converts AC power from an external power supply into DC power and generates DC voltages suitable for the wireless transceiver 221, the controller 222, and the meter reading unit 223.

According this embodiment, the wireless terminals 22 can join the wireless multi-hop network 20 in an orderly manner in the ascending order of their path costs at the point prior to the power failure. Therefore, when a plurality of smart meters 22 restart after they stop their operations due to a wide-area power failure, it is possible to contribute to stable reconfiguration of the wireless multi-hop network 20.

### Other Embodiments

In the second embodiment, the waiting time from the power supply restoration until the start of the joining procedure to the wireless multi-hop network 20 may be determined according to the priority of the smart meter 22 (e.g., according to whether the customer is a large-volume customer or an ordinary customer), or according to the priority of the communication content of the smart meter 22 (e.g., according to whether the transmission is periodic transmission of meter reading data or transmission of control data such as terminal authentication).

The communication control methods at the time of power supply restoration performed by the wireless terminal 12 and the smart meter 22 described in the first and second embodiments may be implemented by causing a computer system including at least one processor to execute a program. Specifically, one or more programs containing a set of instructions for causing a computer system to perform a control algorithm described with reference to FIGS. 3 and 4 and the like may be supplied to the computer system.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Further, the above-described embodiments are merely examples for the application of the technical ideas achieved by the present inventor. That is, needless to say, the technical ideas are not limited to the above-described embodiments and the above embodiments may be modified in various ways.

This application is based upon and claims the benefit of priority from Japanese patent application No. 2014-069042, filed on Mar. 28, 2014, the disclosure of which is incorporated herein in its entirety by reference.

### REFERENCE SIGNS LIST

10, 20 WIRELESS MULTI-HOP NETWORK
11 COORDINATOR
12 WIRELESS TERMINAL
21 CONCENTRATOR
22 SMART METER
50 EXTERNAL NETWORK
51 METER DATA MANAGEMENT SYSTEM (MDMS)
121, 221 WIRELESS TRANSCEIVER
122, 222 CONTROLLER
123, 224 POWER SUPPLY UNIT
223 METER READING UNIT

1. A wireless terminal comprising:
a wireless transceiver configured to communicate with a node; and
a controller comprising at least one hardware processor and configured to adjust, according to magnitude of a path cost to reach a gateway node in a wireless multi-hop network formed by communication of the wireless transceiver, a waiting time before joining the wireless multi-hop network after power supply restoration.

2. The wireless terminal according to claim 1, wherein the controller is adapted to increase the waiting time before joining the wireless multi-hop network in such a manner that the larger the path cost is, the more the waiting time is increased.

3. The wireless terminal according to claim 1, further comprising a power supply circuit configured to supply electric power to the wireless transceiver and the controller, wherein
the power supply restoration is a change to a state where the wireless transceiver and the controller can start their operations by the electric power supplied from the power supply circuit.

4. The wireless terminal according to claim 1, wherein the controller is adapted to determine the waiting time by using the path cost that was stored at least a predetermined time before detection of a power failure in the wireless terminal.

5. The wireless terminal according to claim 1, wherein the controller is adapted to detect a power failure by receiving a notification indicating an occurrence of a power failure from a node in the wireless multi-hop network.

6. The wireless terminal according to claim 1, wherein the controller is adapted to determine the waiting time by using the path cost that was stored when a multi-hop path between the gateway and the wireless terminal had remained unchanged for at least a predetermined time.

7. The wireless terminal according to claim 1, wherein the magnitude of the path cost includes a hop count to the gateway.

8. The wireless terminal according to claim 1, wherein the path cost includes a Received Signal Strength Indicator.

9. The wireless terminal according to claim 1, wherein the gateway relays data between the wireless multi-hop network and an external network.

10. The wireless terminal according to claim 1, wherein
the controller is adapted to adjust the waiting time by adjusting a start timing of a control procedure for joining the wireless multi-hop network, and
the control procedure includes at least one of a procedure for establishing an association with a node, an authentication procedure performed between the wireless terminal and the gateway, and a procedure for setting a multi-hop path between the gateway and the wireless terminal.

11. The wireless terminal according to claim 1, wherein
the wireless multi-hop network conforms to ZigBee, ZigBee PRO, or ZigBee IP,
the controller is adapted to adjust the waiting time by adjusting a start timing of a control procedure for joining the wireless multi-hop network, and
the control procedure includes at least one of (a) transmission of a Beacon Request message to an adjacent node in the wireless multi-hop network, (b) transmission of an Association Request message to the adjacent node, (c) transmission of an authentication request message to the gateway, (d) a procedure for obtaining an IP address, (e) transmission of a DODAG Information Solicitation message to the adjacent node, and (f) transmission of a DODAG Destination Advertisement Object message to the gateway.

12. A metering device comprising:
a wireless terminal according to claim 1; and
a meter reading unit configured to collect meter reading data, wherein
the metering device is configured to transmit the meter reading data through the wireless multi-hop network.

13. A communication control method performed by a wireless terminal, comprising adjusting, according to magnitude of a path cost to reach a gateway node in a wireless multi-hop network, a waiting time before joining the wireless multi-hop network after restoration of power supply to the wireless terminal.

14. The communication control method according to claim 13, wherein the path cost includes a hop count to the gateway.

15. The communication control method according to claim 13, wherein
a plurality of wireless terminals in the wireless multi-hop network are divided into groups according to magnitude of a hop count to the gateway, and
the adjusting comprises adjusting the waiting time before joining the wireless multi-hop network according to magnitude of the hop count.

16. The communication control method according to claim 15, wherein
the adjusting the waiting time comprises adjusting a start timing of a control procedure for joining the wireless multi-hop network, and
the control procedure includes at least one of a procedure for establishing an association with a node in the wireless multi-hop network, an authentication procedure performed between the wireless terminal and the gateway, and a procedure for setting a multi-hop path between the gateway and the wireless terminal.

17. The communication control method according to claim 13, wherein
the wireless multi-hop network conforms to ZigBee, ZigBee PRO, or ZigBee IP,
the adjusting the waiting time comprises adjusting a start timing of a control procedure for joining the wireless multi-hop network, and
the control procedure includes at least one of (a) transmission of a Beacon Request message to an adjacent node in the wireless multi-hop network, (b) transmission of an Association Request message to the adjacent node, (c) transmission of an authentication request message to the gateway, (d) a procedure for obtaining an IP address, (e) transmission of a DODAG Information Solicitation message to the adjacent node, and (f) transmission of a DODAG Destination Advertisement Object message to the gateway.

18. A non-transitory computer readable medium storing a program for causing a computer to perform a communication control method for a wireless terminal, wherein the communication control method comprises adjusting, according to magnitude of a path cost to reach a gateway node in a wireless multi-hop network, a waiting time before joining the wireless multi-hop network after restoration of power supply to the wireless terminal.
